(19) United States
(12) Patent Application Publication
(10) Pub. No.: US 2006/0125995 A1
(43) Pub. Date: Jun. 15, 2006

(54) Liquid crystal display with compact IC chip configuration

(75) Inventors: Ming-Bo Tai, Shenzhen (CN); Che-Kuei Mai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/301,016

(22) Filed: Dec. 12, 2005

(30) Foreign Application Priority Data
Dec. 10, 2004 (TW) 93219896

(51) Int. Cl. G02F 1/1345

(52) U.S. Cl. 349/151

(57) ABSTRACT

A liquid crystal display (4) includes a first panel (41); a second panel (42) opposite to the first panel; a liquid crystal layer sandwiched between the two panels; a backlight module (400) for providing light beams through the panels and the liquid crystal layer; and an integrated circuit (IC) chip (43) disposed on the second panel, facing to the backlight module. Because the liquid crystal display set the IC chip facing the backlight module, which efficiently utilize the space.

### BACKGROUND

1. Field of the Invention

The present invention relates to a liquid crystal displays (LCDs), and particularly to a COG (chip on glass) type LCD.

2. General Background

In recent years, liquid crystal display (LCD) panels have been widely used in place of cathode ray tubes (CRT) for applications such as electronic displays. The LCD panel is first assembled together by filling a liquid crystal material in between an LCD substrate and a transparent glass cover plate. The LCD substrate comprises a multiplicity of switching devices, for electronically turning on and turning off circuits and thereby operating a multiplicity of pixels formed on the LCD panel.

After the assembly of the LCD panel is completed, the LCD panel must be connected to an outside circuit for receiving electronic signals such as those corresponding to images that are to be produced in the panel and displayed. The electronic connections to the LCD panel can be provided by different techniques. A conventional technique is by using a flexible printed circuit board (FPCB) which contains various electronic components welded thereto. The FPCB is frequently manufactured as a conductive copper layer sandwiched between two flexible polyimide cover layers. The flexibility of an FPCB is advantageous when it is installed in an LCD panel.

Referring to FIGS. 3-5, FIG. 3 is a schematic, top plan view of part of a conventional LCD manufactured by a conventional chip on glass (COG) technique, including part of an FPCB thereof. FIG. 4 is a cross-sectional view taken along line IV-IV of FIG. 3. FIG. 5 is a cross-sectional view taken along line V-V of FIG. 4. In the COG technique, an LCD 1 includes an upper panel 11, a lower panel 12, and a liquid crystal layer sandwiched between the upper panel 11 and the lower panel 12. The LCD 1 further includes a backlight module 100 disposed under the lower panel 12 and an integrated circuit (IC) chip 13 mounted directly on the lower panel 12 by utilizing an anisotropic conductive film (ACF) 17. That is, the IC chip 13 faces an end of the upper panel 11. The ACF 17 contains electrically conductive particles (not shown) embedded in an insulative compound.

The lower panel 12 has an input wiring pattern 161 and an output wiring pattern 162 formed thereon. The IC chip 13 includes a first solder bump 151 aligned with the input wiring pattern 161 and a second solder bump 152 aligned with output wiring pattern 162. The IC chip 13 electrically communicates with the lower panel 12 by way of the ACF 17 electrically connecting the first solder bump 151 of the IC chip 13 with the input wiring pattern 161 of the lower panel 12. In addition, the IC chip 13 electrically communicates with an FPCB 14 by way of the ACF 17 electrically connecting the second solder bump 152 of the IC chip 13 with the output wiring pattern 162 of the lower panel 12. The IC chip 13 electrically communicates with the lower panel 12 and the FPCB 14 via the bonding of the ACF 17, which is performed under pressure and heat during manufacturing and assembly. Electrical communication between the first solder bump 151 and the input wiring pattern 161, and between the second solder bump 152 and the output wiring pattern 162, is only established where the conductive particles in the ACF 17 are compressed. That is, the compression is performed selectively and anisotropically, to achieve the desired corresponding electrical connectivity.

As shown in FIGS. 3-4, the lower panel 12 of the LCD 1 is normally provided with a larger area than the upper panel 11. Thus the lower panel 12 provides an exposed edge area necessary for mounting of the IC chip 13 and the FPCB 14. The need for the edge area means that the overall size of the LCD 1 may be excessively large. Thus the LCD 1 may not be suitable for certain compact applications. In addition, the IC chip 13 is essentially mounted directly on the lower panel 12, whereby the IC chip 13 faces the end of the upper panel 11. However, the IC chip 13 is generally thicker and higher than the upper panel 11, which further increases the overall thickness size of the LCD 1.

What is needed, therefore, is a more compact LCD.

### SUMMARY

A preferred embodiment of a liquid crystal display includes: a first panel; a second panel opposite to the first panel; a liquid crystal layer sandwiched between the two panels; a backlight module for providing light beams through the panels and the liquid crystal layer; and an integrated circuit (IC) chip disposed on the second panel, facing the backlight module.

Another preferred embodiment of a liquid crystal display includes: a first panel; a second panel opposite to the first panel; a liquid crystal layer sandwiched between the two panels; a backlight module under the second panel; and an integrated circuit (IC) chip disposed on the second panel, at one side of the backlight module. The IC chip electrically connects with the second panel and is also for electrical connection to an external circuit.

Because the LCD set the IC chip and the backlight module on are set at one side of the second panel, which efficiently utilize the space between the backlight module and the second panel. Therefore, the LCD has a high space utilization ratio and has a small size.

Other advantages and novel features will become more apparent from the following detailed description when taken in conjunction with the accompanying drawings, in which:

### BRIEF DESCRIPTION OF THE DRAWINGS

FIG. 1 is schematic, top plan view of part of an LCD according to a first embodiment of the present invention, including part of an FPCB thereof;

FIG. 2 is a cross-sectional view taken along line II-II of FIG. 1;

FIG. 3 is schematic, top plan view of part of a conventional LCD manufactured by a conventional COG technique, including part of an FPCB thereof; FIG. 5 is a cross-sectional view taken along a line V-V of FIG. 4.

FIG. 4 is a cross-sectional view taken along line IV-IV of FIG. 3; and

FIG. 5 is a cross-sectional view taken along line V-V of FIG. 4.

### DETAILED DESCRIPTION OF PREFERRED EMBODIMENT

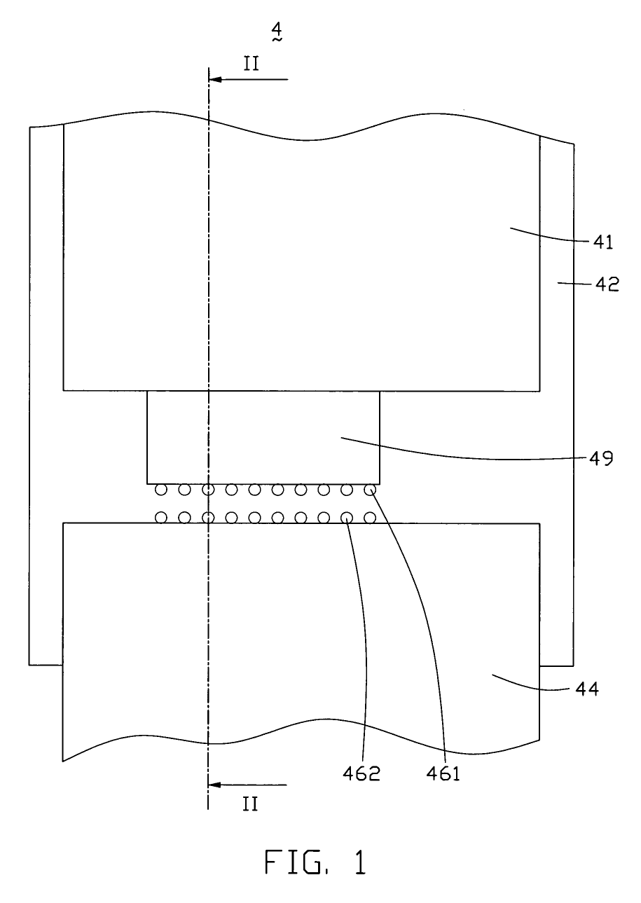

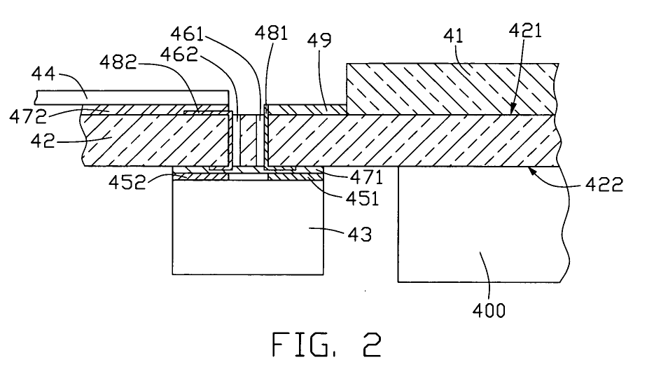

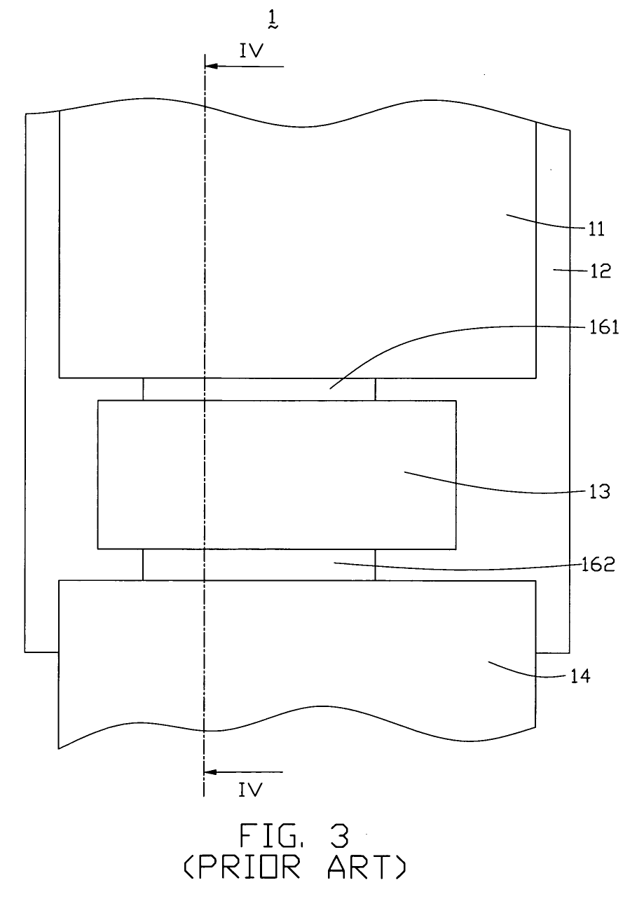

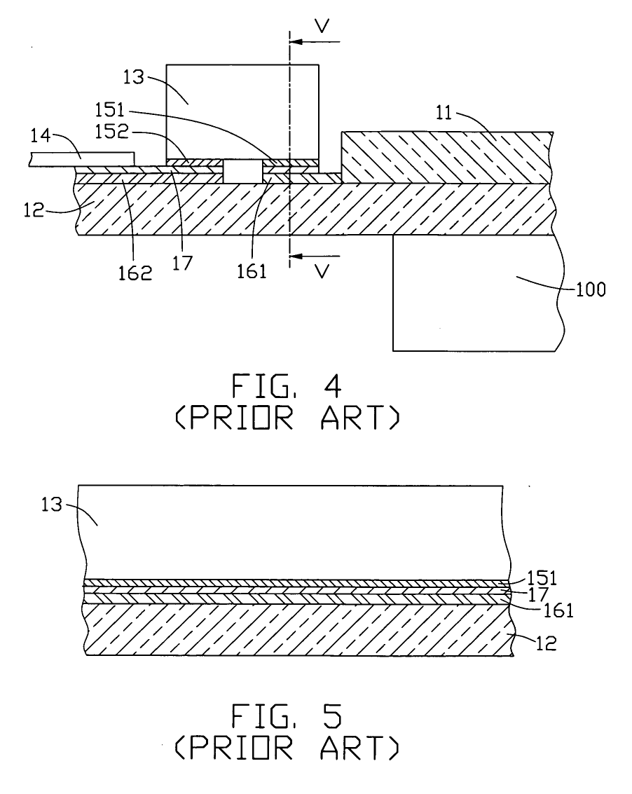

Referring to FIGS. 1-2, an LCD 4 of a first embodiment of the present invention includes an upper panel 41, a lower panel 42, a liquid crystal layer (not shown) having a plurality of liquid crystal molecules, a backlight module 400 under the lower panel 42, an integrated circuit (IC) chip 43 for driving and controlling the panels 41, 42, and an FPCB 44 for communicating with external circuits such as those of an external printed circuit board (not shown). The upper panel 41 and the lower panel 42 are spaced apart from each other, and the liquid crystal layer is disposed therebetween. The lower panel 42 has a larger area than the upper panel 41. Thus the lower panel 42 provides an exposed edge area for mounting of the IC chip 43 and the FPCB 44 thereon.

The lower panel 42 includes a first surface 421 abutting the upper panel 41, a second surface 422 abutting the backlight module 400, an input wiring pattern 49 formed on the first surface 421 for inputting signals to drive the panels 41, 42, a first through hole 461 adjacent to one end of the input wiring pattern 49, and a second through hole 462 adjacent to one end of the FPCB 44. The second through hole 462 is spaced a short distance from and is parallel to the first through hole 461. The lower panel 42 further includes a first guide pattern 481 and a second guide pattern 482. The first guide pattern 481 extends from the second surface 422 through the first through hole 461 to connect with the input wiring pattern 49. The second guide pattern 482 extends from the second surface 422 through the second through hole 462 to the first surface 421.

The IC chip 43 is disposed directly adjacent the second surface 422 of the lower panel 42, such that a side of the IC chip 43 faces a side of the backlight module 400. The IC chip 43 includes a plurality of first solder bumps 451 disposed corresponding to the first guide pattern 481, and a plurality of second solder bumps 452 disposed corresponding to the second guide pattern 482 and spaced apart from the first solder bumps 451. The first and second solder bumps 451, 452 may be spherical or quadrate protrusions. Typically, the first and second solder bumps 451, 452 are plated with gold.

The IC chip 43 electrically communicates with the lower panel 42 via the first ACF 471 and the first guide pattern 481. That is, the first ACF 471 and the first guide pattern 481 electrically connect the first solder bump 451 of the IC chip 43 with the input wiring pattern 49 of the lower panel 42. In addition, the IC chip 43 electrically communicates with the FPCB 44 via the first ACF 471, the second guide pattern 482, and the second ACF 472. That is, the first and second ACFs 471, 472 and the second guide pattern 482 electrically connect the second solder bump 452 of the IC chip 43 with the FPCB 44. The IC chip 43 electrically communicates with the lower panel 42 and the FPCB 44 via the bonding of the first and second ACFs 471, 472, which is performed under pressure and heat during manufacturing and assembly. Electrical communication between the first solder bump 451 and the first guide pattern 481, between the second solder bump 452 and the second guide pattern 482, and between the second guide pattern 482 and the FPCB 44, is only established where conductive particles (not shown) in the respective first and second ACFs 471, 472 are compressed. That is, the compression is performed selectively and anisotropically, to achieve the desired corresponding electrical connectivity.

The manufacturing and assembly process involving bonding of the IC chip 43 on the lower panel 42 includes the following steps: firstly, adhering the first ACF 471 on the second surface 422 of the lower panel 42, with an edge of the first ACF 471 facing the side of the backlight module 400, and the first ACF 471 being positioned corresponding to the first and second through holes 461, 462 and the first and second guide patterns 481, 482; secondly, adhering the second ACF 472 on the first surface 421 of the lower panel 42, with an edge of the second ACF 472 facing an end of the upper panel 41, and the second ACF 472 being positioned corresponding to the second guide pattern 482; thirdly, press-bonding and heating the IC chip 43 on the first ACF 471, thereby electrically connecting the first solder bump 451 of the IC chip 43 with the first guide pattern 481, and the second solder bump 452 of the IC chip 43 with the second guide pattern 482, both connections being attained through corresponding of the conductive particles of the first ACF 471; and finally press-bonding and heating the FPCB 44 on the second ACF 472, thereby electrically connecting the FPCB 44 with the second guide pattern 482, the connection being attained through corresponding of the conductive particles of the second ACF 472.

In operation, the FPCB 44 provides external signals to the IC chip 43 through the second ACF 472, the second guide pattern 482, the first ACF 471, and the second solder bump 452 of the IC chip 43. When the IC chip 43 receives the external signals, the IC chip 43 sends driving signals to a plurality of switching elements (not shown) formed on the lower panel 42. The driving signals are sent through the first solder bump 451, the first ACF 471, the first guide pattern 481, and the input wiring pattern 49 on the lower panel 42, and drive the switching elements to turn on or turn off. Thereby the LCD 4 displays corresponding images.

In summary, the LCD 4 has the IC chip 43 set on the second surface 422 of the lower substrate 42, whereby the side of the IC chip 43 faces the side of the backlight module 400. This efficiently utilize a space that exists adjacent the backlight module 400 and the lower panel 42. Therefore, the LCD 4 has a high space utilization ratio and a compact size.

It is to be understood, however, that even though numerous characteristics and advantages of the preferred embodiment have been set forth in the foregoing description, together with details of the structure and function of the embodiment, the disclosure is illustrative only, and changes may be made in detail, especially in matters of shape, size, equivalent material and arrangement of parts within the principles of the invention to the full extent indicated by the broad general meaning of the terms in which the appended claims are expressed.

What is claimed is:

1. A liquid crystal display, comprising:
a first panel;
a second panel opposite to the first panel;
a liquid crystal layer sandwiched between the two panels;
a backlight module for providing light beams sequentially through the second panel, the liquid crystal layer and the first panel; and
an integrated circuit (IC) chip disposed on the second panel, facing the backlight module.

2. The liquid crystal display as claimed in claim 1, wherein the second panel comprises a first surface facing the first panel, and a second surface facing and/or adjacent to the backlight module.

3. The liquid crystal display as claimed in claim 2, wherein the second panel further comprises an input wiring pattern formed thereon, for inputting signals to drive the first and second panels.

4. The liquid crystal display as claimed in claim 3, wherein the second panel further comprises a first through hole, and a second through hole spaced apart from the first through hole.

5. The liquid crystal display as claimed in claim 4, wherein the second panel further comprises a first guide pattern formed on the second surface, the first guide pattern connecting with the input wiring pattern.

6. The liquid crystal display as claimed in claim 5, wherein the first guide pattern extends through the first through hole to connect with the input wiring pattern.

7. The liquid crystal display as claimed in claim 4, wherein the second panel further comprises a second guide pattern formed on the first and the second surfaces.

8. The liquid crystal display as claimed in claim 7, wherein the second guide pattern extends through the second through hole.

9. The liquid crystal display as claimed in claim 8, wherein the IC chip comprises a first bump and a second bump.

10. The liquid crystal display as claimed in claim 9, wherein the first bump is disposed corresponding to the first guide pattern, and the second bump is disposed corresponding to the second guide pattern.

11. The liquid crystal display as claimed in claim 10, wherein the first bump electrically connects with the first guide pattern through a first anisotropic conductive film (ACF).

12. The liquid crystal display as claimed in claim 11, wherein the second bump electrically connects with the second guide pattern through the first ACF.

13. The liquid crystal display as claimed in claim 12, further comprising a flexible printed circuit board (FPCB), wherein the second guide pattern electrically connects with the FPCB through a second ACF.

14. The liquid crystal display as claimed in claim 13, wherein the IC chip electrically connects with the input wiring pattern of the second panel through the first bump, the first ACF, and the first guide pattern.

15. The liquid crystal display as claimed in claim 13, wherein the IC chip electrically connects with the FPCB through the second bump and the second guide pattern.

16. A liquid crystal display, comprising:
a first panel;
a second panel opposite to the first panel;
a liquid crystal layer sandwiched between the two panels;
a backlight module under the second panel; and
an integrated circuit (IC) chip disposed on the second panel, at one side of the backlight module;
wherein the IC chip electrically connects with the second panel, and is also for electrical connection to an external circuit.

17. The liquid crystal display as claimed in claim 16, wherein the IC chip electrically connects with the second panel and is for electrical connection to an external circuit board via an anisotropic conductive film.

18. The liquid crystal display as claimed in claim 16, further comprising a flexible printed circuit board (FPCB), wherein the IC chip electrically connects with the FPCB, and the FPCB is for electrical connection to the external circuit.

19. A liquid crystal display, comprising:
a first panel;
a second panel opposite to the first panel;
a liquid crystal layer sandwiched between the two panels;
a backlight module for providing light beams sequentially through the second panel, the liquid crystal layer and the first panel; and
an integrated circuit (IC) chip located on a same side of said second panel with said backlight module.
